(19) United States
(12) Patent Application Publication
(10) Pub. No.: US 2025/0347529 A1
(43) Pub. Date: Nov. 13, 2025

(54) SYSTEMS AND METHODS FOR PREDICTIVE VEHICLE NAVIGATION

(71) Applicant: Ford Global Technologies, LLC, Dearborn, MI (US)

(72) Inventors: Andrew Brown, Royal Oak, MI (US); Keith Weston, Canton, MI (US); Asa Hattar, Livonia, MI (US); Anthony Maraldo, Southgate, MI (US); John Robert Van Wiemeersch, Novi, MI (US); Stuart C. Salter, White Lake, MI (US)

(73) Assignee: Ford Global Technologies, LLC, Dearborn, MI (US)

(21) Appl. No.: 18/659,599

(22) Filed: May 9, 2024

(51) Int. Cl. G01C 21/36; B60W 60/00; G06V 10/60; G06V 10/764; G06V 20/56

(52) U.S. Cl. CPC G01C 21/3691; G01C 21/3602; G06V 10/60; G06V 10/764; G06V 20/56; B60W 60/001; B60W 2420/403; B60W 2555/20

(57) ABSTRACT

Systems and methods for predictive vehicle navigation are provided. The systems and methods may be used to identify locations that currently include environmental conditions requested to be viewed by a user. Similarly, predictions of locations that are likely to include the environmental conditions in the future may also be identified (for example, if the user indicates they desire to view the environmental condition at some point in the future). Recommendations for locations may be presented to the user via a user interface of a vehicle (or a smartphone application or other type of device). In scenarios where the user desires to view the environmental condition in the future, the prediction may involve using a generative model to generate an image or video of a location at a future time. The user may then select a location and navigate to the location at the desired time to view the environmental condition. Alternatively, the vehicle may autonomously navigate to the location.

### FIELD

The present disclosure relates to systems and methods for predicting future environmental conditions such that a vehicle may navigate to a location including such environmental conditions.

### BACKGROUND

Sightseeing is a popular activity. People often drive to certain locations to view different types of environmental conditions, such as leaves changing colors during the fall, flowers blooming in the spring, winter snowfall, etc. “Fall leaf tours” are common weekend trips in certain regions of the United States, Canada, and other countries that have significant deciduous foliage. However, it may be difficult to predict when certain environmental conditions that are desired to be viewed will be present in a particular location.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIGS. 1A-1B depict an example of a use case for predictive vehicle navigation in accordance with the present disclosure.

FIG. 2 depicts an environment in which techniques and structures for providing the systems and methods disclosed herein may be implemented.

FIG. 3 depicts a flow diagram of a method for predictive vehicle navigation in accordance with the present disclosure.

### DETAILED DESCRIPTION

### Overview

The present disclosure describes systems and methods for predictive vehicle navigation. Particularly, a vehicle may receive a user request including an indication of an environmental condition that a user desires to experience (for example, the user may input the request via a human-machine interface of the vehicle, a smartphone application associated with the vehicle, or via any other type of device, system, etc.). Based on this request, the vehicle may predict when the environmental condition is likely to exist in one or more geographical locations. An indication of the location(s) in which the environmental condition is predicted to exist (as well as time periods during which the environmental condition is predicted to exist) may then be presented to the user. The user may then navigate to one or more of the location(s) to experience the environmental condition at the future time. The vehicle may be also be an autonomous vehicle that automatically navigates to one or more of the identified locations(s).

An environmental condition may refer to any naturally-occurring or man-made condition that may exist at a location. For example, naturally-occurring conditions may include seasonal conditions, such as fall leave colors, winter snow, spring flower blooms, etc. Naturally-occurring conditions may also include weather patterns, such as rain, sunshine, volcanic eruptions, hurricanes and tornadoes (which may be desirable to track by “storm chasers”), waves suitable for recreational activities such as surfing, lunar eclipses, etc. Naturally-occurring conditions may also include wildlife, such as animals that only migrate to a location at certain times of the year, wildlife that is only observable in general at certain times of the year, etc. Naturally-occurring conditions may also include non-transient conditions, such as types of naturally-occurring features, such as mountains or lakes, which may only exist in certain regions.

A man-made condition may include any other type of condition that is not naturally-occurring. Non-limiting examples of such conditions may include temporary events, such as a traveling circus or carnival, a car show, an art festival, a concert, a farmer's market, a block party, an outlet mall being open for shopping, and/or any other type of event, gathering of people, existence of an object or objects, etc.

The above-mentioned naturally-occurring and man-made conditions are merely exemplary and an “environmental condition” as described herein may generally refer to anything that a user desires to view and/or experience, such a condition in nature, a man-made event, an object, person, or animal that the user can view, etc.

Any current environmental conditions for a location and/or predicted future environmental conditions for the location may be determined based on data captured at the location. In embodiments, the data may be captured by one or more vehicles (for example, a car, train, boat, drone, and/or any other type of vehicle) that are traversing through the location. For example, a vehicle may traverse through a location as part of a daily commute of a user. As the vehicle traverses the location, the vehicle may capture images of the location using one or more cameras of the vehicle. As another example, the vehicle may traverse through the location as a portion of a route of a road trip of a user (that is, the vehicle may not necessarily frequent the location). Once captured by the vehicle, the data may then be transmitted to a remote device for storage and processing, such as a remote server. Some or all of the data may also be stored in memory of the vehicle and/or may be transmitted to another vehicle for processing and/or storage through any known wired or wireless communication protocols.

The vehicle may also capture any other types of data about the location using any other types of sensors as well. For example, the vehicle may capture temperature or other weather-related data, radar data, LIDAR data, latitude and longitude data (or other types of location data), and/or any other type of data that may be used to identify environmental conditions in the location (as well as other types of relevant information that may be presented to a user or considered by a vehicle in addition to the existence of the environmental conditions).

Additionally, multiple vehicles (and/or multiple different types of vehicles) may be used to capture data for the same location to provide a more robust data set. For example, data from different vehicles may be compared to determine if there are any discrepancies between the data. Using multiple vehicles to capture data in the same location may also allow for a larger volume of data to be obtained. For example, a first vehicle may traverse through the location at a first time and a different vehicle may traverse through the location at a second time. Having data for both times rather than just having data captured by one vehicle at one time may provide more insight into the environmental conditions at the location and how the conditions may be changing over time. The vehicles that capture the data may not necessarily all be the same. For example, a first vehicle that captures data may be a car and a second vehicle may be a drone.

Further, the data that is captured may not necessarily only be limited to data relating to the requested environmental condition, but may also include other types of data as well. For example, if the user requests to travel to a location in which fall leaves may be observed, the data that is obtained is not limited to only including images of leaves (or other data that may be used to ascertain leaf colors). The data may also include other types of data, such as a popularity of a location (such as a number of people that travel to the region on a daily basis or other period of time), historical, current, or upcoming weather conditions at the location, traffic conditions at the location, availability of campsites or hotels at the location, road conditions at the location, availability of restaurants and gas stations, and/or any other types of information that may be relevant to the user or to a system (e.g., the vehicle, a remote server, etc.) determining whether to recommend a location to the user.

In some instances, requests may be provided to one or more vehicles to traverse to a location to capture data, even if the vehicle was not originally going to traverse to that location. For example, if a user of a first vehicle indicates that they desire to view fall leaves in the mountains, a request may be transmitted to a second user of a second vehicle who lives in a nearby mountainous region. The user may not necessarily intend to travel into the mountains on that particular day (or in general). However, the second user may receive the request and decide to traverse into the mountains such that the second vehicle may capture the images and/or other data (for example, based on a financial or other sort of incentive provided to the user). The request may be received via a mobile device application, via a user interface of the second vehicle, etc. In some instances, the request may only be transmitted to users and/or vehicles (e.g., autonomous vehicles) that have “opted-in” to traversing to locations to capture data based on requests.

Some or all of this process may also be automated and may be performed by a vehicle without requiring a user to navigate the vehicle to perform the data capture. For example, rather than the request being viewed and approved by the second user, the second vehicle may be an autonomous vehicle and the request may be an instruction that is transmitted to the second vehicle to automatically traverse to the location and capture data about the location. The second vehicle may then, based on the request, autonomously navigate to the location to capture the desired data. The autonomous vehicle may also capture this data along normal routes (for example, the aforementioned commute performed by a user) without requiring the request to be received by the autonomous vehicle.

Although the example of vehicles capturing this data is provided, the data may also be captured in any other manner by any other type of device. For example, the data may also be captured by infrastructure at the location, such as traffic cameras, security cameras, and/or any other types of cameras or other types of sensors that may be used to capture the data about the location. Some or all of the data may also be captured by satellites, such as satellite imagery of the location. Any of the vehicle, infrastructure, or other types of devices used to capture the data may be in communication with one another and/or a remote system (such as a remote server) in this data capture process. For example, vehicles and infrastructure may communicate via known wireless or wired protocols, such as vehicle-to-vehicle (V2V) communications, vehicle-to-infrastructure (V2I) communications, etc. Thus, the data may be obtained in a crowdsourced manner.

Any of the data that is captured may be processed to identify current environmental conditions at the location at which the data was captured. The data may also be processed to predict future environmental conditions at the location. This data processing may be performed by the vehicle or infrastructure (or other type of device) that captured the data. The data may also be transmitted to a remote device, such as a remote server, to perform the processing. The data may also be transmitted to another vehicle to perform the processing. For example, the vehicle through which a user provides a request to view the environmental condition may receive data from other vehicles or infrastructure (or other devices) at remote locations. The processing of the data may also be performed by any combination of such devices such that the processing may be shared by the devices. For example, some of the processing may be performed by a remote server and some of the processing may be performed by one or more vehicles.

In certain embodiments, the data processing may be performed by one or more machine learning models. Any number of different types of machine learning models may be used (for example, neural networks, linear regression models, Naïve Bayes, and/or any other types of machine learning models). In some instances, a single model may be used to perform any of the processing described herein. In some instances, multiple models may be used in combination (in serial and/or in parallel with one another). While reference is made herein specifically to machine learning models, any other type of artificial intelligence in general may also be used as well.

The one or more machine learning models may also be pre-trained to perform any of these analyses. The pre-training may be performed in any suitable manner. For example, the one or more models may be trained with a training data set. The training data set may include input data, such as images of a location (or any other types of data) that may be provided to the one or more models. The training data set may also include ground truth data, which may provide an indication of a desired output of the one or more machine learning models. That is, the one or more models may be trained in a supervised manner, in some cases (however, the one or more models may also be trained in any other manner).

In some instances, different machine learning models may be trained to perform specific tasks. For example, certain machine learning models may be trained to identify specific environmental conditions (e.g., a first model may be trained to identify fall leaves in images, a second model may be trained to identify a farmer's market in images, a third model may be trained to identify car shows, etc.). By using individual models to perform more specific tasks, the accuracy of the predictions performed by the models may be enhanced. However, a single model may be used to perform predictions associated with any type of environmental condition or a smaller number of models may be trained to perform predictions for multiple different types of environmental conditions.

In addition to being pre-trained, the one or more machine learning models may be iteratively trained over time to enhance the accuracy of the models. For example, if a vehicle traverses to a location to capture data at that location, additional data may be captured while the vehicle is at the location to determine the accuracy of the models in recommending that the user traverse to the location at the particular time to experience the environmental condition. This feedback mechanism used to continuously train the model may be performed in a number of different ways. As a first example, the vehicle may capture data (such as images, videos, and/or other types of data) while at the location and the data may be analyzed to determine if the environmental condition in the location matches the requested environmental condition by the user. For example, an image may be processed to determine if the leaves at the location are “fall colors”. As another example, the second user may be prompted (for example, via a user interface of the vehicle, a smartphone application, etc.) to indicate whether the location does have the requested environmental condition. This information may also be determined in any other manner. Based on this feedback, the model may be re-trained or fine-tuned to more effectively perform tasks in the future.

The one or more machine learning models may also be trained to classify any received data. The data that is captured at the location may be captured under different conditions. For the one or more machine learning models to be able to properly analyze the data, the one or more machine learning models may identify the existence of such conditions and the manner in which the conditions impact the data. For example, the colors of leaves that appear in an image may vary depending on the lighting conditions present at the location. This may occur based on various factors, such as time of day, weather, etc. Continuing this same example, the one or more models may be trained to identify that an image of the location was captured at night time. The one or more models may also be trained to determine how the lighting condition changes the appearance of the color of the leaves in the captured image. The one or more models may either simply make note of this impact of the lighting conditions on the color or may performed post-processing on the image to generate a new image with the appearance of the leaves in other lighting conditions (such as during day time).

In certain embodiments, the one or more models may also more specifically normalize the data such that a more effective comparison of the data may be performed. Continuing the lighting conditions example, the one or more models may perform post-processing on all captured images such that the resulting post-processed images all have the appearance of the same lighting conditions. This normalization process may also be performed in any other manner on any other types of data as well (normalizing for lighting conditions in images is merely exemplary).

As an alternative to this post-processing of the data, the data may be filtered such that only data that satisfies certain criteria is used. For example, rather than post-processing images of leaves captured at night such that the resulting image shows the same leaves under lighting conditions associated with daytime, only the images showing the leaves during the daytime may be used by the one or more models. Additionally, data capture may only be performed by devices in similar conditions. Returning to the scenario in which a vehicle is requested to traverse to an area to capture data, certain parameters of this capture process may be provided to the vehicle (for example, the vehicle should only traverse to the location to capture the data at certain times, under certain weather conditions, etc.).

The one or more machine learning models may also include a generative model that may generate images and/or videos that illustrate how a location may appear at a future time. These generated images and/or videos of the location may then be transmitted to the user who made the request such that the user may be provided with a visual indication of conditions that are likely to occur at the location in the future. For example, the leaves in a region may be just beginning to change to fall colors. The generative model may automatically be provided with data associated with that region and may automatically generate an image and/or video of the appearance of the leaves in the region a week in the future. The generated images and/or video may then be transmitted to a vehicle of the requesting user for presenting via an interface of the vehicle. The images and/or video may also be transmitted to another device, such as a smartphone of the user. In this manner, even though the leaves are not necessarily already the color that the user desires to view, the user may still be presented with an estimation of the appearance of the leaves in the future, such that the user may then decide if they desire to traverse to that location by vehicle a week in the future to view the leaves.

The images and/or video generated by the generative model may also be provided as an input to other machine learning models that are used to make location recommendations to users and/or vehicles and perform other tasks as described herein. That is, rather than the images and/or video being output by the generative model and transmitted for presentation to a user along with a recommendation, the images and/or video may be used by the one or more machine learning models to determine whether to provide the recommendation of the user to traverse to the location (or the automated instruction for the vehicle to navigate to the location).

The one or more machine learning models may also be trained to predict environmental conditions in locations from which current data has not been obtained or is otherwise unavailable. For example, historical data may exist for a first location, but data may not have been recently obtained for the first region. However, data for a second location may have been obtained and there may be similarities between the first location and the second location. For example, the first location and the second location may both be located in the same region of a country and may be exposed to the same general climate. Given the similarities between the first location and the second location, the current data for the second location may be used to predict environmental conditions in the first location as well. As an example of a benefit of this type of prediction, current data may be available for a location that is further away from a user but data may not be available for a location that is closer to the user. Even though current data is not available for the location that is closer to the user (which may be a more desirable location given the shorter travel time to the location), the data from the similar, other location may be used such that closer location may still be analyzed and potentially provided as a recommendation to the user (or an instruction to an autonomous vehicle).

The one or more machine learning models may also be provided with constraints that may be used to limit the scope of the search for locations in which the environmental condition may currently exist or may exist in the future. The user may also provide these constraints at any other time (for example, the user may initially establish the constraints and the constraints may also apply to subsequent requests made by the user).

In some instances, the constraints may be user-configurable constraints. For example, the user may indicate when they make a request that they only desire to drive a maximum distance from their current location. As another example, the user may indicate they only desire to go to locations that are accessible by paved roads or locations that do not require the user to pass through a toll booth. As yet another example, the user may indicate that they only desire to travel to locations at which hotel accommodations may be made. The constraints may also include any other types of constraints that the user may establish.

Some or all of the constraints may also be automatically established by the vehicle. For example, the vehicle may be an electric vehicle and may disregard locations that are beyond the maximum range of the vehicle and are only accessible via routes that do not include charging stations. As another example, if the vehicle is a sports car that is not suitable for off-road driving, then the vehicle may disregard locations that require driving off of a paved road.

The output(s) produced by the one or more machine learning models may include a recommendation for one or more locations that include the environmental condition or are predicted to include the environmental condition (if the user indicates they desire to experience the environmental condition at a time in the future). For example, the recommendation may be provided to a user interface of the vehicle, a smartphone application, etc. The user may select from one of the recommended locations and may navigate to the location (at the time the user desired to experience the environmental condition) using the vehicle.

Alternatively, one (or multiple) of the locations identified by the one or more machine learning models may automatically be selected by the vehicle and the vehicle may automatically begin autonomously navigating to the location (or may store an indication to autonomously navigate to the location at a later time at which the user desires to view the environmental condition). For example, the user may make a request for the system to identify locations where the user can view fall leaves two weeks from the current date. The system may identify candidate locations and may store an indication that the vehicle should navigate to an identified location two weeks in the future. At the point in time at which the user desires to view the fall leaves, the user may again request to travel to a location to view fall leaves and the vehicle may then autonomously navigate to the pre-determined location. Alternatively, the vehicle may automatically determine that it is the date and/or time that the user previously indicated they desire to view fall leaves and may automatically navigate to the determined location without requiring another input from the user.

The user may also indicate that they desire to experience the environmental condition at the present time rather than in the future. In these scenarios, the autonomous vehicle may automatically begin navigating to an identified location in which the environmental condition exists. The vehicle may, in some cases, prompt the user to approve the location before the vehicle begins to navigate.

Additionally, this autonomous vehicle functionality may allow a user to view a certain environmental condition that is occurring in real-time without having to physically traverse to the location of the environmental condition. For example, the user may indicate that they desire to view snowfall but do not actually want to traverse to such a region themselves. Once such a location is identified, the autonomous vehicle may automatically traverse to the location while the user remains at home. The autonomous vehicle may capture a video feed of the location while the autonomous vehicle is traversing the location and the user may view the video feed on another device, such as a smartphone, laptop or desktop computer, television, etc. Thus, the user is able to view a live environmental condition without having to physically travel to the location in which the environmental condition exists.

To identify current locations in which the environmental condition exists or predict locations in which the environmental condition is likely to exist in the future, the one or more machine learning models may be provided with information relating to the request and any user-defined (or otherwise defined) constraints associated with the request (as well as any other relevant information that may be used to identify candidate location(s)). For example, the one or more machine learning models may be provided with a request to identify a location within 100 miles in which a user may view fall leaves. The request may also include an indication of a timeframe in which the user desires to experience the environmental condition (now or at a designated point in the future).

The systems and method described herein provide an enhancement to vehicle navigation technologies by, among other enhancements, allowing such navigation systems to predict locations in which a user may experience different requested environmental conditions either currently or at a designated point in the future. The enhanced systems and methods are also able to visually (or otherwise) indicate to the user the environmental conditions that are likely to exist at a given location (for example, by generating a predicted image or video by a generative model), provide recommendations for locations to which the user may traverse currently or at a future time, and/or autonomously navigate the user to the location without requiring any manual indication by the user.

Additionally, although the systems and methods described herein are primarily described as relating to identifying desirable environmental conditions, a similar approach may be used to identify undesirable environmental conditions as well. For example, the systems and methods may be used to determine whether a location is experiencing, or is predicted to experience, snow that may result in difficult driving conditions in a location.

Furthermore, although reference is made herein to determining locations at which certain desired environmental conditions may occur in the future, the systems and methods may also be used to identify where such environmental conditions currently exist. That is, a user may desire to navigate to a location including a certain environmental condition now rather than at a time in the future (for example, the user desires to go on an impromptu weekend day trip to the mountains to see fall leaves). The one or more models may obtain data from vehicles, infrastructure, or other devices in various locations to determine one or more locations at which the environmental condition currently exists. Even if data does not exist for a specific location, the one or more models may also predict whether the environmental condition currently exists in that location in a similar manner as described above.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

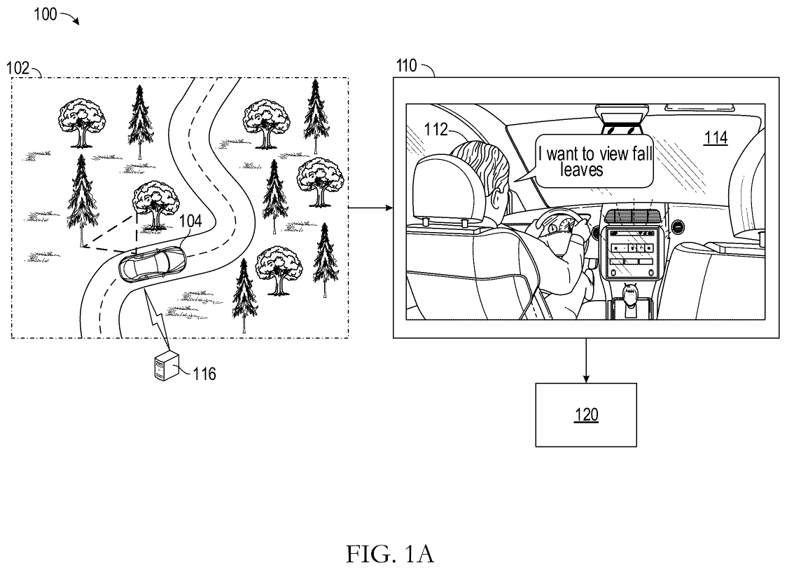

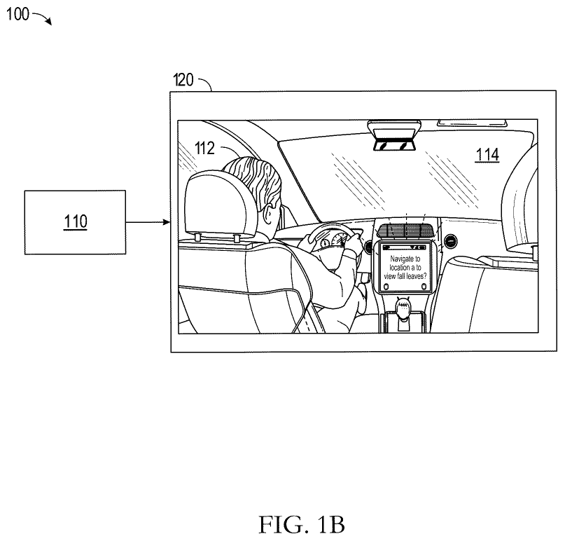

FIGS. 1A-1B depict an example use case 100. The scenario depicted in the use case 100 is provided for illustrative purposes only and the systems and methods may also be applicable to any other number of use cases involving any other types of environmental conditions as well. The use case 100 begins with scene 102 in which a first vehicle 104 is traversing a mountainous road including a substantial amount of foliage. The first vehicle 104 may be driven by a user who lives in a region including the road, for example. However, the first vehicle 104 may also be driven by a user who lives a distance from the road and is merely traveling through the region using the road. The first vehicle 104 may also be an autonomous vehicle that is traversing the road without a user.

While the first vehicle 104 is traversing the road, the first vehicle 104 captures data about environmental conditions in the environment in which the road exists. For example, the first vehicle 104 may capture images of the road, the foliage around the road, other vehicles on the road, events occurring in the region, etc. The images themselves may be stored in memory of the first vehicle 104 and/or may be transmitted to a remote device, such as remote server 116, for storage. The use of images is merely exemplary and any other types of data may also be captured by the first vehicle 104 using any other types of sensors or combinations of different types of sensors.

The images may also be processed by the first vehicle 104, the remote server 116, and/or any other vehicle, device, etc. That is, rather than simply storing the images, one or more machine learning models may be used to classify the images to provide an indication of environmental conditions shown in the images. For example, the one or more machine learning models may receive an image of foliage on the side of the road as an input and may produce an output indicating that the image shows fall leaves (which is an example of an environmental condition). This classification may be stored as a tag in association with the image (for example, as metadata associated with the image or in any other suitable manner). Other information may also be stored in association with the image, such as the specific location with which the image is associated.

Following scene 102, the use case 100 proceeds to scene 110 in which a user 112 provides a request to experience an environmental condition. In this use case 100, the environmental condition is fall-colored leaves. The scene 110 shows the request as being a voice command (“I want to view fall leaves”) provided by the user 112 to a vehicle 114. However, the request may also be provided in any other manner. For example, the user 112 may manually type or otherwise input the request into an HMI of the vehicle 114 or another device, such as a smartphone or other type of mobile device.

The second vehicle 114 may transmit the request to the remote server 116 that has stored the images captured by the first vehicle 104. Alternatively, the second vehicle 114 may perform direct communications with the first vehicle 104 to obtain the same or similar information. Based on the request, the one or more machine learning models analyzes the stored images and determine that the environmental condition the user seeks (the fall leaves) is present in the classified image of the leaves by the road associated with the first location.

The one or more machine learning models may also be able to predict the appearance of the first location at a point in time in the future indicated in the original request by the user. For example, the one or more machine learning models may predict what the leaves at the first location will look like after a week passes. For example, the one or more machine learning models may consider multiple images that were captured on the road over a period of time. Based on a determined rate of change of the color of the leaves in the images, the one or more machine learning models may be able to predict the manner in which the appearance of the leaves will change over time into the future.

Finally, scene 120 shows the HMI of the vehicle providing a recommendation for the user to traverse to the first location in a week's time using the second vehicle 112 to view the fall leaves at the first location. The HMI of the second vehicle 114 also presents an image including a predicted appearance of the first location in a week. As aforementioned, this predicted image may be generated using a generative model. Alternatively, an indication of the first location may be provided to the second vehicle 112, and the second vehicle 112 may then automatically navigate to the first location such that the user may then experience the fall leaves at the first location. Alternatively, the user 112 may indicate that they desire to view the fall leaves now and the second vehicle 112 may automatically traverse to the location (or may begin autonomous navigation based on a user confirmation that they desire to traverse to the location).

While reference may be made generally herein to the identification of a single location that is recommended to a user (or a single location that is automatically selected as a destination by the vehicle), multiple alternative locations may also be identified and/or presented to the user as well. Continuing the example in which the user requests to traverse to a location to view fall leaves, the vehicle may present to the user multiple options of locations including fall leaves and the user may select one of the locations. The locations that are identified and presented to the user may be locations that satisfy any constraints provided by the user along with the request. For example, the user may indicate that they want to view fall leaves within a two hour drive from their home. Given this constraint, the vehicle may present any locations in which the user may view the fall leaves within a two hour drive from the user's home.

In embodiments, the vehicle may also present other information that may assist the user in selecting one of multiple potential destination locations. For example, the vehicle may provide information indicating that one location is proximate to a large forest and thus has the potential for viewing more fall leaves and is an hour and a half from the user's home and may provide information indicating that another location includes less trees (and thus not as many fall leaves) but is ten minutes from the user's home. This additional information may allow the user to weight the benefits and downsides of visiting the alternative locations to assist the user in making a selection. This information may be presented to the user in any suitable format (for example, auditory, visual, etc.). In one particular example, the locations may be presented to the user on a map via the HMI of the vehicle or a mobile device application, for example. Along with this information may be presented actual images of the locations or generated images of the locations (using a generative model as described herein) as well.

Further, in some scenarios a location may not be identified that falls within the user's defined constraints. Continuing the same example, fall leaves may only be visible three hours from the user's home. In such scenarios, the vehicle may recommend locations that do not necessarily satisfy the defined constraints but are reasonably outside of the defined constraints. In this example, the vehicle may indicate that the user is not able to view any fall leaves within a two-hour drive, but may be able to instead travel to a location within a three-hour drive (rather than simply returning no results to the user). If the vehicle is configured to automatically select a location and navigate to the location, then the vehicle may prompt the user to confirm that the vehicle may travel the additional distance outside of the original constraint.

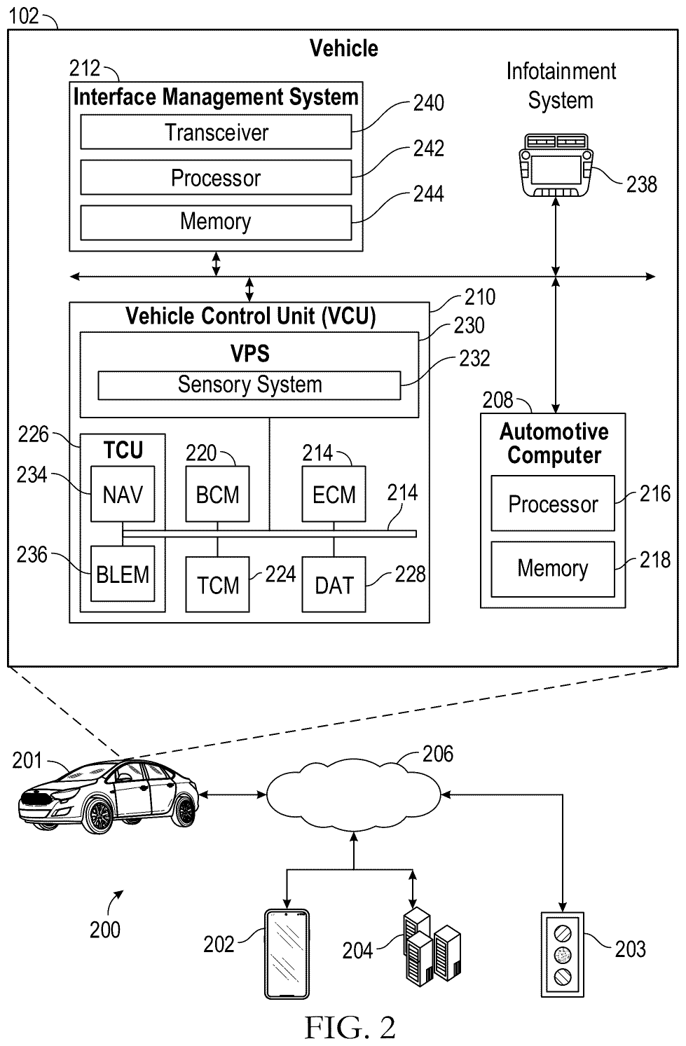

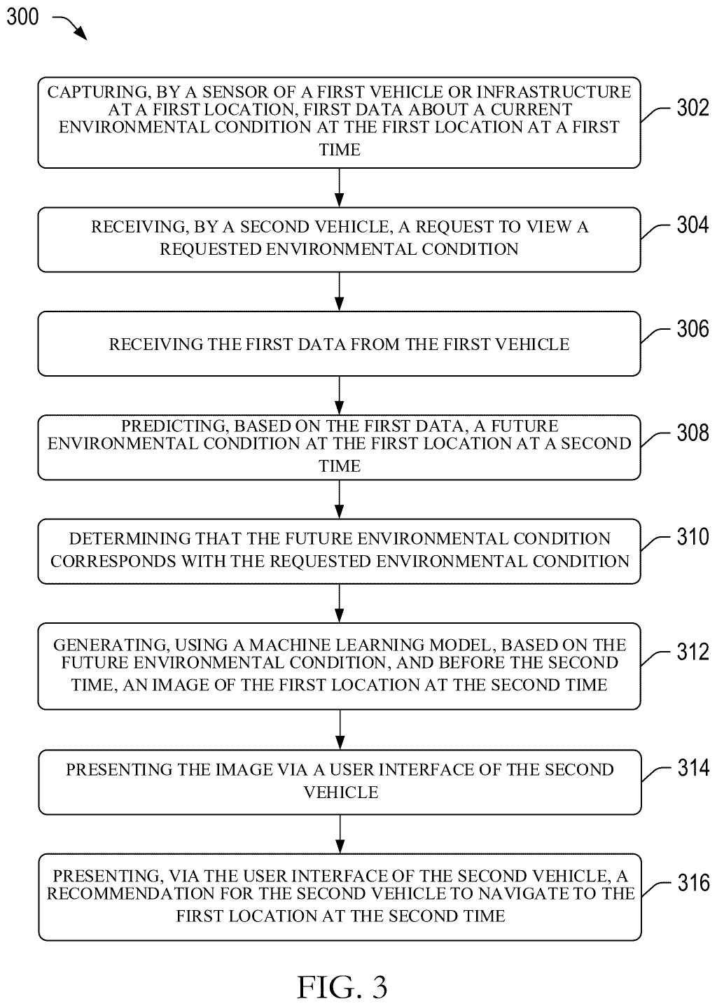

FIG. 2 depicts a block diagram of a system 200 for predictive vehicle navigation in accordance with the present disclosure.

The vehicle 102 and/or the driver 112 implement and/or perform operations, as described here in the present disclosure, in accordance with the owner manual and safety guidelines. In addition, any action taken by the driver 112 based on the notifications/alerts provided by the vehicle 102 should comply with all the rules specific to the location and operation of the vehicle 102 (e.g., Federal, state, country, city, etc.). The notifications/alerts, as provided by the vehicle 102, should be treated as suggestions and only followed according to any rules specific to the location and operation of the vehicle 102.

The system 200 may include the one or more vehicles 201, a user device 202, infrastructure 203, and one or more servers 204 (or server 204) communicatively coupled with each other via one or more networks 206 (or a network 206). Any reference to a single element (e.g., a “server 204,” etc.) may similarly refer to any other number of such elements. Similarly, reference to multiple of such elements may also refer to a single element as well.

The user device 202 may be associated with a user (such as user 112 in use case 100, for example) and may be, for example, a mobile phone, a laptop, a computer, a tablet, a wearable device, or any other similar device with communication capabilities. The server 204 (which may be the same as remote server 116, for example) may be configured to receive data from the one or more vehicles 201, infrastructure 203, and/or any other devices that are configured to capture data about a location. The server 204 may also be configured to process any of the data as described herein. For example, the server 204 may host the one or more machine learning models that may be used to perform any of the processing as described herein (such as identifying locations at which environmental conditions currently exist or are predicted to exist in the future). As aforementioned, some or all of the processing may also be performed by the one or more vehicles 201, the user device 202, etc. Thus, the one or more machine learning models may also (or alternatively) be hosted on the one or more vehicles 201, the user device 202, etc.

The network 206 illustrates an example communication infrastructure in which the connected devices discussed in various embodiments of this disclosure may communicate. The network 206 may be and/or include the Internet, a private network, public network or other configuration that operates using any one or more known communication protocols such as transmission control protocol/Internet protocol (TCP/IP), Bluetooth®, BLE, Wi-Fi based on the Institute of Electrical and Electronics Engineers (IEEE) standard 802.11, Ultra-Wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

Any of the elements of the system 200 may also form a mesh network. This may be beneficial in scenarios in which a particular device is not connected to a wide-area network and is not able to transmit data over large distances (for example, from a vehicle to server 204). In such scenarios, the device that is unable to perform long-range communications may still be able to perform short-range communications with other proximate devices. For example, traffic infrastructure may capture an image of a location but may be unable to transmit the data to server 204. Instead, the traffic infrastructure may transmit the image to a vehicle in the vicinity and the vehicle may then transmit the data to server 204. Such data transmissions may also be performed between any other types of devices.

The one or more vehicles 201 may include a plurality of units including, but not limited to, an automotive computer 208, a Vehicle Control Unit (VCU) 210, and an interface management system 212 (or system 212). The VCU 210 may include a plurality of Electronic Control Units (ECUs) 214 disposed in communication with the automotive computer 208.

In some aspects, the user device 202 may be configured to connect with the automotive computer 208 and/or the system 212 via the network 206, which may communicate via one or more wireless connection(s), and/or may connect with the one or more vehicles 201 directly by using near field communication (NFC) protocols, Bluetooth® protocols, Wi-Fi, Ultra-Wideband (UWB), and other possible data connection and sharing techniques.

The automotive computer 208 and/or the system 212 may be installed anywhere in the one or more vehicles 201, in accordance with the disclosure. Further, the automotive computer 208 may operate as a functional part of the system 212. The automotive computer 208 may be or include an electronic vehicle controller, having one or more processor(s) 216 and a memory 218. Moreover, the system 212 may be separate from the automotive computer 208 (as shown in FIG. 2) or may be integrated as part of the automotive computer 208.

The processor(s) 216 may be disposed in communication with one or more memory devices disposed in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable storage medium or memory storing an interface management program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 210 may share a power bus with the automotive computer 208 and may be configured and/or programmed to coordinate the data between vehicle systems, connected servers (e.g., the server 204), and other vehicles (not shown in FIG. 2) operating as part of a vehicle fleet. The VCU 210 may include or communicate with any combination of the ECUs 214, such as, for example, a Body Control Module (BCM) 220, an Engine Control Module (ECM) 222, a Transmission Control Module (TCM) 224, a Telematics Control Unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the one or more vehicles 201 using radio waves, sitting area buckle sensors, sitting area sensors, a Light Detecting and Ranging (“lidar”) sensor, door sensors, proximity sensors, temperature sensors, wheel sensors, one or more ambient weather or temperature sensors, vehicle interior and exterior cameras, steering wheel sensors, a vehicle accelerometer, a vehicle gyroscope, a vehicle magnetometer, ultrasonic sensors, etc.

In some aspects, the vehicle sensory system 232 may be configured to capture data about a location. For example, the vehicle sensory system 232 may include one or more cameras that may be configured to capture images and/or video of a location. The vehicle sensory system 232 may also include any other types of sensors that may capture any other types of data (for example, temperature sensors, location sensors, radar, LIDAR, accelerometers, etc.).

In some aspects, the VCU 210 may control vehicle operational aspects and implement one or more instruction sets received from the server 204, from one or more instruction sets stored in the memory 218, including instructions operational as part of the system 212.

The TCU 226 may be configured and/or programmed to provide vehicle connectivity to wireless computing systems onboard and off board the one or more vehicles 201 and may include a Navigation (NAV) receiver 234 for receiving and processing a GPS signal, a BLE® Module (BLEM) 236, a Wi-Fi transceiver, an ultra-wideband (UWB) transceiver, and/or other wireless transceivers (not shown in FIG. 2) that may be configurable for wireless communication (including cellular communication) between the one or more vehicles 201 and other systems (e.g., a vehicle key fob, not shown in FIG. 2, the server 204, the user device 202, the infrastructure 203, etc.), computers, and modules. The TCU 226 may be disposed in communication with the ECUs 214 by way of a bus.

The ECUs 214 may control aspects of vehicle operation and communication using inputs from human drivers, inputs from the automotive computer 208, the system 212, and/or via wireless signal inputs/command signals received via the wireless connection(s) from other connected devices, such as the server 204, the user device 202, the interface 110, among others.

The BCM 220 generally includes integration of sensors, vehicle performance indicators, and variable reactors associated with vehicle systems and may include processor-based power distribution circuitry that may control functions associated with the vehicle body such as lights, windows, security, camera(s), audio system(s), speakers, wipers, door locks and access control, various comfort controls, etc. The BCM 220 may also operate as a gateway for bus and network interfaces to interact with remote ECUs (not shown in FIG. 2). In some aspects, the BCM 220 may be configured to cause and control the vehicle movement and the vehicle steering wheel rotation based on the command signals (or the user inputs) obtained from the interface 110 and/or the system 212.

The DAT controller 228 may provide Level-1 through Level-3 automated driving and driver assistance functionality (or any other type of autonomous driving functionality at any level) that may include, for example, active parking assistance, vehicle backup assistance, and/or adaptive cruise control, among other features. The DAT controller 228 may also provide aspects of user and environmental inputs usable for user authentication.

In some aspects, the automotive computer 208 may connect with an infotainment system 238 (or a vehicle Human-Machine Interface (HMI)). The infotainment system 238 may include a touchscreen interface portion and may include voice recognition features, biometric identification capabilities that may identify users based on facial recognition, voice recognition, fingerprint identification, or other biological identification means. In other aspects, the infotainment system 238 may be further configured to receive user instructions via the touchscreen interface portion and/or output or display notifications, navigation maps, etc. on the touchscreen interface portion.

The computing system architecture of the automotive computer 208, the VCU 210, and/or the system 212 may omit certain computing modules. It should be readily understood that the computing environment depicted in FIG. 2 is an example of a possible implementation according to the present disclosure, and thus, it should not be considered as limiting or exclusive.

In accordance with some aspects, the system 212 may be integrated with and/or executed as part of the ECUs 214. The system 212, regardless of whether it is integrated with the automotive computer 208 or the ECUs 214, or whether it operates as an independent computing system in the one or more vehicles 201, may include a transceiver 240, a processor 242, and a computer-readable memory 244.

The transceiver 240 may be configured to receive information/inputs from one or more external devices or systems, e.g., the user device 202, the server 204, the infrastructure 203, and/or the like, via the network 206. Further, the transceiver 240 may transmit notifications, requests, signals, etc. to the external devices or systems. In addition, the transceiver 240 may be configured to receive information/inputs from vehicle components such as the vehicle sensory system 232, one or more ECUs 214, and/or the like. Further, the transceiver 240 may transmit signals (e.g., command signals) or notifications to the vehicle components such as the BCM 220, the infotainment system 238, and/or the like.

The processor 242 and the memory 244 may be same as or similar to the processor 216 and the memory 218, respectively. In some aspects, the processor 242 may utilize the memory 244 to store programs in code and/or to store data for performing aspects in accordance with the disclosure. The memory 244 may be a non-transitory computer-readable storage medium or memory storing the interface management program code. In some aspects, the memory 244 may additionally store any data obtained by the one or more vehicles 201, infrastructure 203, etc. any post-processed data (e.g., classified images, etc.), any requests to view different types of environmental conditions, and/or any other types of information.

The method 300 starts at step 302. At step 302, the method 300 may include capturing, by a sensor of a first vehicle or infrastructure at a first location, first data about a current environmental condition at the first location at a first time. At step 304, the method 300 may include receiving, by a second vehicle, a request to view a requested environmental condition. At step 306, the method 300 may include receiving, the first data from the first vehicle. At step 308, the method 300 may include predicting, based on the first data, a future environmental condition at the first location at a second time. At step 310, the method 300 may include determining that the future environmental condition corresponds with the requested environmental condition. At step 312, the method 300 may include generating, using a machine learning model, based on the future environmental condition, and before the second time, an image of the first location at the second time. At step 314, the method 300 may include presenting the image via a user interface of the second vehicle. At step 316, the method 300 may include presenting, via the user interface of the second vehicle, a recommendation for the second vehicle to navigate to the first location at the second time.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
memory that stores computer-executable instructions; and
one or more processors configured to access the memory and execute the computer-executable instructions to:
receive a request to view a requested environmental condition;
receive first data about a current environmental condition at a location at a first time from a sensor of a first vehicle or infrastructure;
predict, based on the first data, a future environmental condition at the location at a second time;
determine that the future environmental condition corresponds with the requested environmental condition;
generate, using a machine learning model, based on the future environmental condition, and before the second time, an image of the location at the second time; and
present the image via a user interface of a second vehicle; and
present, via the user interface of the second vehicle, a recommendation for the second vehicle to navigate to the location at the second time.

2. The system of claim 1, wherein the second vehicle is further configured to:
autonomously navigate to the location at the second time.

3. The system of claim 1, wherein the one or more processors are further configured to execute the computer-executable instructions to:
receive second data about a past environmental condition at the location, wherein prediction of the future environmental condition is further based on the second data.

4. The system of claim 1, wherein determination that the future environmental condition corresponds with the requested environmental condition further comprises classify, by the machine learning model, the image.

5. The system of claim 4, wherein classification of the image further comprises determining a lighting condition present in the image, wherein the lighting conditions is based on at least one of: a time of day or a weather condition.

6. The system of claim 1, transmitting, by the first vehicle, the first data to the second vehicle.

7. The system of claim 1, wherein the sensor is a camera.

8. A method comprising:
receiving, by a first vehicle, a request associated with a requested environmental condition;
receiving first data about a current environmental condition at a location at a first time from a sensor of a second vehicle or infrastructure;
predicting, based on the first data, a future environmental condition at the location at a second time;
determining that the future environmental condition corresponds with the requested environmental condition;
generating, using a machine learning model, based on the future environmental condition, and before the second time, an image of the location at the second time;
presenting the image via a user interface of the first vehicle; and
presenting, via the user interface of the first vehicle, a recommendation for the second vehicle to navigate to the location at the second time.

9. The method of claim 8, further comprising:
autonomously navigating, by the first vehicle, to the location at the second time.

10. The method of claim 8, further comprising:
receiving second data about a past environmental condition at the location, wherein predicting the future environmental condition is further based on the second data.

11. The method of claim 8, wherein determining that the future environmental condition corresponds with the requested environmental condition further comprises classifying, by the machine learning model, the image.

12. The method of claim 11, wherein classifying the image further comprises determining a lighting condition present in the image, wherein the lighting conditions is based on at least one of: a time of day or a weather condition.

13. The method of claim 8, further comprising:
transmitting, by the second vehicle, the first data to the first vehicle.

14. The method of claim 8, wherein the sensor is a camera.

15. A vehicle comprising:
memory that stores computer-executable instructions; and
one or more processors configured to access the memory and execute the computer-executable instructions to:
receive a request to view a requested environmental condition;
receive first data from a sensor of a different vehicle or infrastructure at a location at a first time;
predict, based on the first data, a future environmental condition at the location at a second time;
determine that the future environmental condition corresponds with the requested environmental condition;
generate, using a machine learning model, based on the future environmental condition, and before the second time, an image of the location at the second time; and
present the image via a user interface of the vehicle; and
present, via the user interface of the vehicle, a recommendation for the vehicle to navigate to the location at the second time.

16. The vehicle of claim 15, wherein the one or more processors are further configured to execute the computer-executable instructions to:
autonomously navigate the vehicle to the location.

17. The vehicle of claim 15, wherein the one or more processors are further configured to execute the computer-executable instructions to:
receive second data about a past environmental condition at the location, wherein prediction of the future environmental condition is further based on the second data.

18. The vehicle of claim 15, wherein determination that the future environmental condition corresponds with the requested environmental condition further comprises classification, by the machine learning model, of the image.

19. The vehicle of claim 18, wherein classification of the image further comprises determination that a lighting condition present in the image, wherein the lighting conditions is based on at least one of: a time of day or a weather condition.

20. The vehicle of claim 15, wherein the sensor is a camera.
